(19) United States
(12) Patent Application Publication
(10) Pub. No.: US 2026/0222690 A1
(43) Pub. Date: Jul. 30, 2026

(54) IMAGE CAPTURING APPARATUS, LIGHT EMISSION CONTROL SYSTEM, CONTROL METHOD, AND STORAGE MEDIUM

(71) Applicant: CANON KABUSHIKI KAISHA, Tokyo (JP)

(72) Inventor: TOMOKUNI HIROSAWA, Kanagawa (JP)

(21) Appl. No.: 19/453,480

(22) Filed: Jan. 20, 2026

(30) Foreign Application Priority Data
Jan. 28, 2025 (JP) 2025-012290

(51) Int. Cl. H04N 23/74; H04N 23/56; H04N 23/661

(52) U.S. Cl. CPC H04N 23/74; H04N 23/56; H04N 23/661

(57) ABSTRACT

There is provided an image capturing apparatus that operates as a Peripheral compliant with a BLE standard. A control unit controls transmission of an advertising signal. A first receiving unit receives a response signal corresponding to the advertising signal from each of a plurality of light emitting apparatuses that operate as Centrals compliant with the BLE standard. The response signal includes light emitting apparatus information. A grouping unit divides the plurality of light emitting apparatuses into two or more groups based on a plurality of pieces of the light emitting apparatus information corresponding to the plurality of light emitting apparatuses. The control unit performs control such that, for each of the two or more groups, a single advertising signal common to one or more light emitting apparatuses in the group is transmitted to the one or more light emitting apparatuses.

### BACKGROUND

### Field of the Technology

The present disclosure relates to an image capturing apparatus, a light emission control system, a control method, and a storage medium.

### Description of the Related Art

As a method for achieving multi-flash light emission with wireless strobes using Bluetooth (registered trademark), a method has conventionally been used where multi-strobe control is performed by setting wireless strobes as Peripherals, setting a camera as a Central, and having the camera and strobes join a common network. A method such as pairing to establish a linked state among the devices can be used as the method for having the devices join the common network.

For example, according to the technique disclosed in Japanese Patent Laid-Open No. 2023-121328, an information terminal outputs a light emission instruction to a lighting apparatus that has joined a network, and the lighting apparatus that has received the light emission instruction performs light emission control.

The above-described conventional technique requires the camera to operate as the Central. However, when the camera operates as the Central, the camera cannot connect to a control apparatus such as a smartphone that operates as a Central. The camera therefore cannot be controlled from a control apparatus such as a smartphone, which reduces the usability for the user.

### SUMMARY

The present disclosure provides, in at least some aspects thereof, a technique which enables an image capturing apparatus operating as a Peripheral to efficiently control a plurality of light emitting apparatuses.

According to one aspect of the present disclosure, there is provided an image capturing apparatus that operates as a Peripheral compliant with a Bluetooth Low Energy (BLE) standard, the image capturing apparatus comprising: a control unit configured to control transmission of an advertising signal; a first receiving unit configured to receive a response signal corresponding to the advertising signal from each of a plurality of light emitting apparatuses that operate as Centrals compliant with the BLE standard, the response signal including light emitting apparatus information; and a grouping unit configured to divide the plurality of light emitting apparatuses into two or more groups based on a plurality of pieces of the light emitting apparatus information corresponding to the plurality of light emitting apparatuses, wherein the control unit performs control such that, for each of the two or more groups, a single advertising signal common to one or more light emitting apparatuses in the group is transmitted to the one or more light emitting apparatuses.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram illustrating the configuration of a strobe 100 (a light emitting apparatus) and a camera 110 (an image capturing apparatus) included in a light emission control system.

FIG. 1B is a conceptual diagram illustrating the light emission control system.

FIGS. 2A to 2C are diagrams illustrating the data structure of an advertising signal according to Periodic Advertising with Responses (PAwR).

FIG. 3 is a flowchart illustrating operations performed by the camera 110.

FIG. 4 is a flowchart illustrating details of group setting processing (step S308 of FIG. 3).

FIGS. 5A and 5B are diagrams illustrating a relationship between advertising signals and groups.

FIG. 6 is a flowchart illustrating operations performed by the strobe 100.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of Light Emission Control System

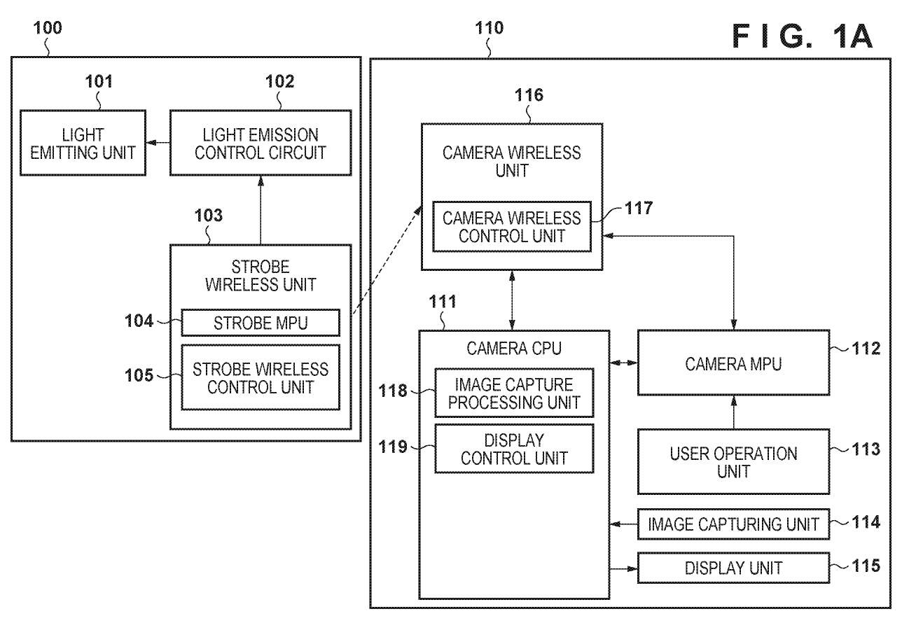

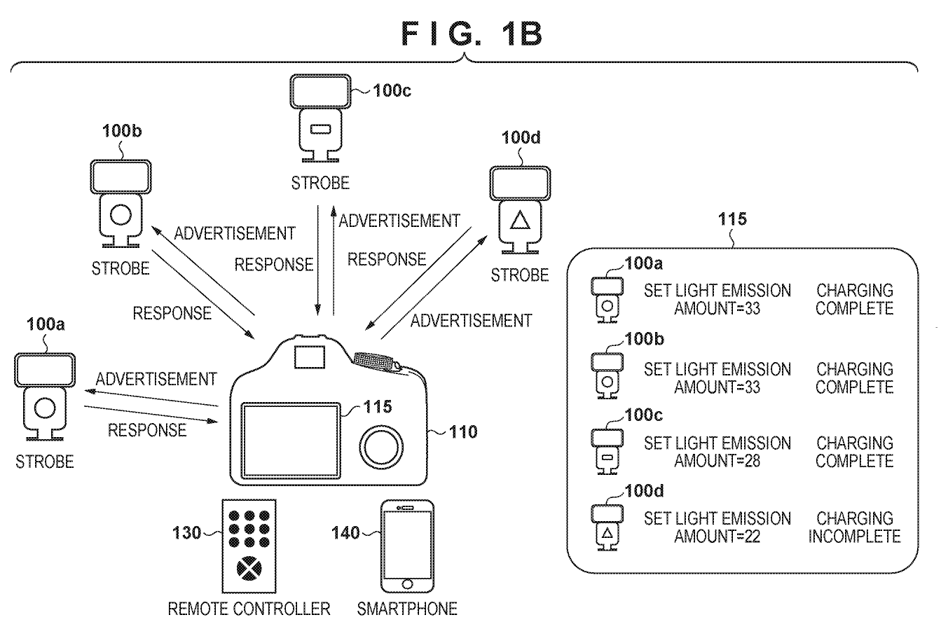

The configuration of a light emission control system will be described with reference to FIGS. 1A and 1B. FIG. 1A is a block diagram illustrating the configuration of a strobe 100 (a light emitting apparatus) and a camera 110 (an image capturing apparatus) included in the light emission control system. The strobe 100 includes a light emitting unit 101, a light emission control circuit 102 that controls the start and stop of light emission by the light emitting unit 101, and a strobe wireless unit 103.

The light emitting unit 101 is constituted by a discharge tube, a booster circuit, a main capacitor, a reflector, a zoom optical system, and the like. The light emitting unit 101 emits light by boosting a voltage using the booster circuit, charging the main capacitor with electrical energy, and emitting the charged electrical energy. The maximum light emission amount of the strobe 100 (the maximum amount of light that can be emitted) is determined in accordance with the discharge tube in the light emitting unit 101 and the illumination range of the zoom optical system.

The strobe wireless unit 103 includes a strobe microprocessing unit (MPU) 104 and a strobe wireless control unit 105.

The strobe MPU 104 is provided with a ROM (not shown) storing programs for controlling the operations of the strobe 100, a RAM (not shown) storing variables, and an Electrically Erasable Programmable Read-Only Memory (EEPROM; not shown) storing various types of parameters. The strobe 100 operates by the strobe MPU 104 executing programs stored in the ROM. The strobe MPU 104 controls the light emission control circuit 102 by communicating with the light emission control circuit 102 through a communication method such as SPI communication or I2C communication.

The strobe wireless control unit 105 performs communication that is based on the Bluetooth (registered trademark) Low Energy (BLE) standard. The strobe wireless control unit 105 has a Periodic Advertising with Responses (PAwR) function, which is included in Bluetooth 5.4 and later.

The strobe 100 can operate as a BLE Central and perform BLE communication with a Peripheral.

The camera 110 includes a camera central processing unit (CPU) 111, a camera microprocessing unit (MPU) 112, a user operation unit 113, an image capturing unit 114, a display unit 115, and a camera wireless unit 116.

The camera MPU 112 is provided with a ROM (not shown) storing programs for controlling the operations of the camera 110, a RAM (not shown) storing variables, and an Electrically Erasable Programmable Read-Only Memory (EEPROM; not shown) storing various types of parameters. The camera 110 operates by the camera MPU 112 executing programs stored in the ROM. The camera MPU 112 controls the camera CPU 111 and the camera wireless unit 116 by communicating with the camera CPU 111 and the camera wireless unit 116 through a communication method such as SPI communication or I2C communication.

The image capturing unit 114 is constituted by an image sensor such as a CMOS sensor, a CCD, or the like. The image capturing unit 114 photoelectrically converts light received through an optical system and outputs the resulting electrical signal to an image capture processing unit 118.

The display unit 115 is constituted by an LCD, OLED, or the like. The display unit 115 is controlled by a display control unit 119, and can display input display data to a user.

The camera CPU 111 includes the image capture processing unit 118 and the display control unit 119. The camera CPU 111 controls the camera wireless unit 116 by communicating with the camera wireless unit 116 through a communication method such as SPI communication or I2C communication.

The image capture processing unit 118 performs image processing on captured image data obtained from the image capturing unit 114, and performs processing for generating still image data, moving image data, and the like.

The display control unit 119 outputs data to be displayed to the display unit 115. Image data generated by the image capture processing unit 118, data for displaying menus, and the like can be given as examples of the data to be displayed.

The camera wireless unit 116 includes a camera wireless control unit 117. The camera wireless control unit 117 performs communication that is based on the BLE standard. The camera wireless control unit 117 has a PAwR function.

The camera 110 can operate as a BLE Peripheral and communicate wirelessly with a device that operates as a Central such as the strobe 100, a remote controller 130 (FIG. 1B), and a smartphone 140 (FIG. 1B). The remote controller 130 and the smartphone 140 are examples of control apparatuses that operate as Centrals compliant with the BLE standard, and can send shooting instructions to the camera 110 in response to user operations.

FIG. 1B is a conceptual diagram illustrating the light emission control system. The light emission control system includes the camera 110 and a plurality of the strobes 100 (four strobes 100a to 100d, in the example in FIG. 1B). All of the strobes 100a to 100d have the same configuration as the strobe 100 described with reference to FIG. 1A, but the specifications of the light emitting units thereof are not necessarily the same. As such, the maximum light emission amounts of the strobes 100a to 100d are not necessarily the same.

In this specification, when there is no need to make any particular distinctions among the four strobes 100a to 100d, the letters “a” to “d” will be omitted, and the term “strobe 100” will simply be used.

In the example in FIG. 1B, the remote controller 130 and the smartphone 140, which can operate as the BLE Centrals, are located within a range at which BLE communication with the camera 110 is possible.

The camera 110 issues an advertising signal based on the BLE communication standard. The BLE communication standard uses radio waves in the 2.4 GHz band. The camera 110 can notify other devices of information about the camera 110 using advertising signals.

Upon receiving an advertising signal, the strobe 100 returns a response signal using the PAwR function. By including information on the strobe 100 itself (strobe information) in the response signal, the strobe 100 can notify the camera 110 of the strobe information. The strobe information includes the maximum light emission amount, a set light emission amount (the amount of light actually emitted in response to a light emission instruction), charging information indicating whether charging of the strobe 100 (and more precisely, charging of the main capacitor provided in the light emitting unit 101) is complete, and the like. The strobe information may include at least one of (i) the maximum light emission amount and the set light emission amount of the strobe 100 and (ii) the charging information of the strobe 100.

The camera 110 displays the strobe information received through the response signal in the display unit 115. This makes it possible to notify the user of information about strobes which the camera 110 can control. In the example in FIG. 1B, of the strobe information, the set light emission amount and the charging information are displayed in the display unit 115.

Note that the camera 110 can display a setting screen for setting the set light emission amount in the display unit 115 in response to a user instruction made through the user operation unit 113. By operating the user operation unit 113, the user can, in the setting screen, set the set light emission amount for each strobe 100 within a range not exceeding the maximum light emission amount.

In addition to the strobe information, the camera 110 can obtain, in the same manner, information about the remote controller 130, the smartphone 140, and the like, and can display the obtained information in the display unit 115.

### Data Structure of Advertising Signal

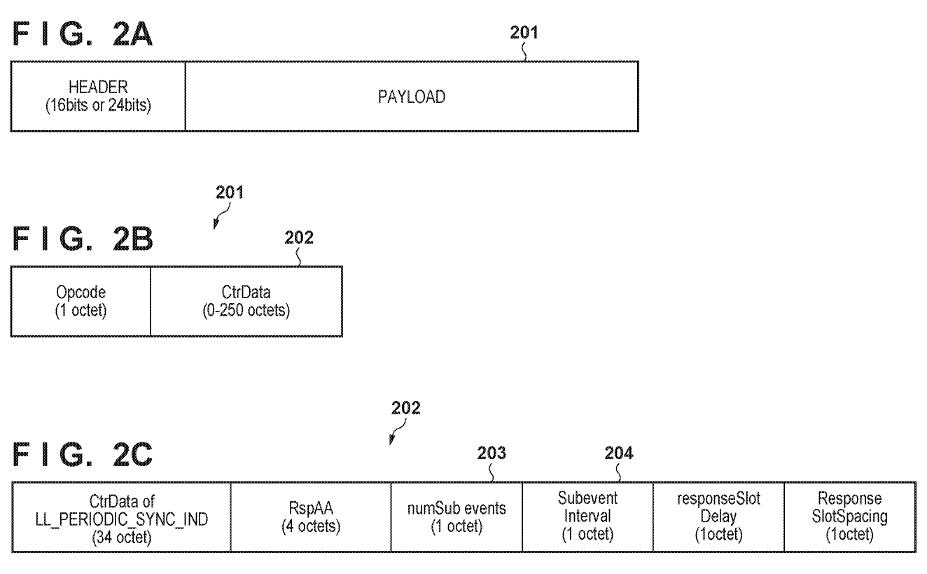

The data structure of the advertising signal according to PAwR will be described with reference to FIGS. 2A to 2C. FIG. 2A is a diagram illustrating a common format for the data channel PDU of the advertising signal. The data channel PDU packet is constituted by a header and a payload 201.

FIG. 2B is a diagram illustrating the payload 201 in detail. CtrData 202 is a packet that stores the specific communication content of the data channel PDU.

FIG. 2C is a diagram illustrating the CtrData 202 in detail. The camera 110 can store a Subevent number of the PAwR communication defined in the Bluetooth standard in numSubevents 203. The camera 110 can also store a Slot number of the PAwR communication defined in the Bluetooth standard in ResponseSlotSpacing 204. The camera 110 can create two or more groups for sorting the plurality of strobes 100 by assigning each group unique Subevent and Slot numbers compliant with the BLE standard. In group setting processing performed in step S308 (described later), one or more strobes 100 in the same group can be set by assigning unique and shared Subevent and Slot numbers to the one or more strobes 100 in the same group.

The remaining parameters are not necessary for describing the configuration of the present embodiment, and will therefore not be mentioned here.

### Operations by Camera 110

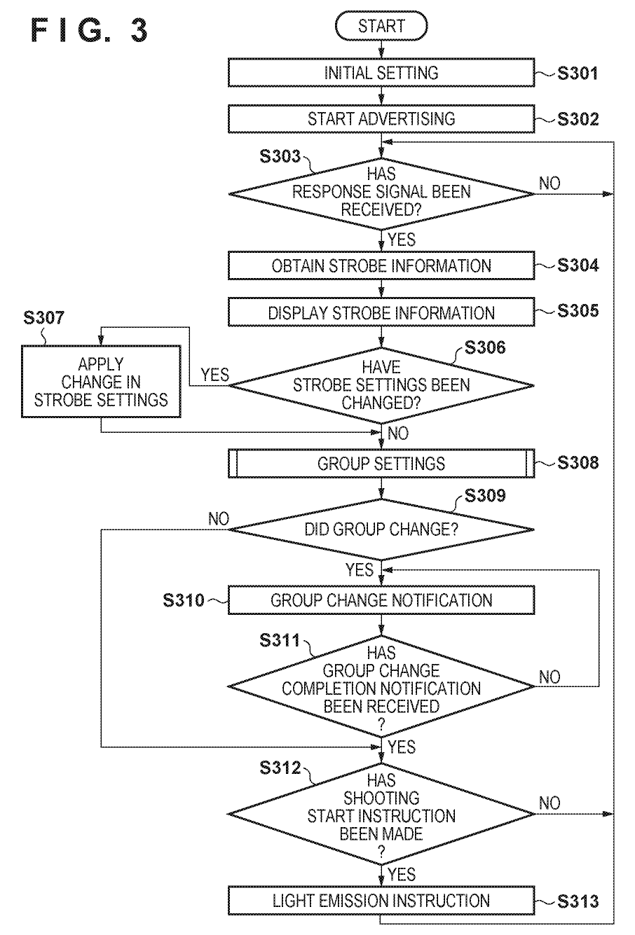

FIG. 3 is a flowchart illustrating operations performed by the camera 110. Unless otherwise specified, the processes in the respective steps of this flowchart are realized by the camera MPU 112 executing programs stored in the ROM. The processing of this flowchart starts when a power switch (not shown) of the camera 110 is turned on.

In step S301, the camera MPU 112 sets the memory content, executed programs, and the like to an initialized state, and executes preparatory operations such as powering on the camera CPU 111, the image capturing unit 114, the display unit 115, and the camera wireless unit 116.

In step S302, the camera MPU 112 issues an advertising start instruction to the camera wireless unit 116. Having received the advertising start instruction, the camera wireless unit 116 starts transmitting an advertising signal according to PAwR to send information about the camera 110. The transmission of the advertising signal is repeated periodically.

In step S303, the camera MPU 112 determines whether the camera wireless unit 116 has received a response signal from the strobe 100. The camera MPU 112 repeats the determination of step S303 until a response signal is received. Once a response signal is received, the sequence moves to step S304.

Note that the response signal is received from each of the plurality of strobes 100 included in the light emission control system (the strobes 100a to 100d, in the example in FIG. 1B). Each time a response signal is received from any one of the plurality of strobes 100, the camera 110 executes the processing from step S304 onward for the received response signal.

In step S304, the camera MPU 112 obtains the strobe information included in the response signal, and stores the strobe information in the RAM. As described earlier, the strobe information can include the maximum light emission amount, the set light emission amount, the charging information, and the like. Also as described earlier, the user can set the set light emission amount within a range not exceeding the maximum light emission amount for each of the strobes 100. The maximum light emission amount obtained in step S304 is used as a maximum value for the set light emission amount (the upper limit of a settable value).

In step S305, the camera MPU 112 instructs the display control unit 119 of the camera CPU 111 to display the strobe information obtained in step S304 in the display unit 115. In the example in FIG. 1B, of the strobe information, the set light emission amount and the charging information are displayed in the display unit 115.

In step S306, the camera MPU 112 determines whether the user has changed the strobe settings. If the strobe settings have been changed, the sequence moves to step S307, whereas if the strobe settings have not been changed, the sequence moves to step S308.

The strobe settings include, for example, the set light emission amount and a strobe use setting (a setting for whether or not to use the strobe). As described earlier, in the setting screen displayed in the display unit 115, the user can set the set light emission amount within a range not exceeding the maximum light emission amount for each of the strobes 100. In the setting screen, the user can also set whether or not to use each of the strobes 100 (whether or not to cause each of the strobes 100 to emit light during shooting).

Note that the user can also change the strobe settings using the remote controller 130 or the smartphone 140 rather than the user operation unit 113. In this case, the remote controller 130 or the smartphone 140 transmits an instruction to the camera 110 to change the strobe settings in response to an operation for changing the strobe settings made by the user. The camera MPU 112 changes the strobe settings in response to the received instruction to change the settings.

In step S307, the camera MPU 112 reflects the change in the strobe settings on the display unit 115.

In step S308, the camera MPU 112 makes strobe group settings (forms a group of a plurality of the strobes 100) on the basis of the strobe information obtained in step S304 and the strobe settings.

The reason for setting a group of the strobes is as follows. The advertising signal according to PAwR can include different parameters for each device receiving the advertising signal. However, if the camera 110 transmits individual advertising signals to the respective strobes 100, the amount of data transmitted becomes enormous. As a result, the timing at which the instruction is received differs greatly between the strobe 100 corresponding to the advertising signal transmitted first (e.g., the strobe 100a in FIG. 1B) and the strobe 100 corresponding to the advertising signal transmitted last (e.g., the strobe 100d in FIG. 1B).

Accordingly, assigning two or more strobes 100 controllable using common parameters to the same group makes it possible to reduce the amount of data transmitted and reduce differences in the timings at which the instructions are received by the strobes 100. As a result, differences in the light emission timings between the strobes 100 can be reduced.

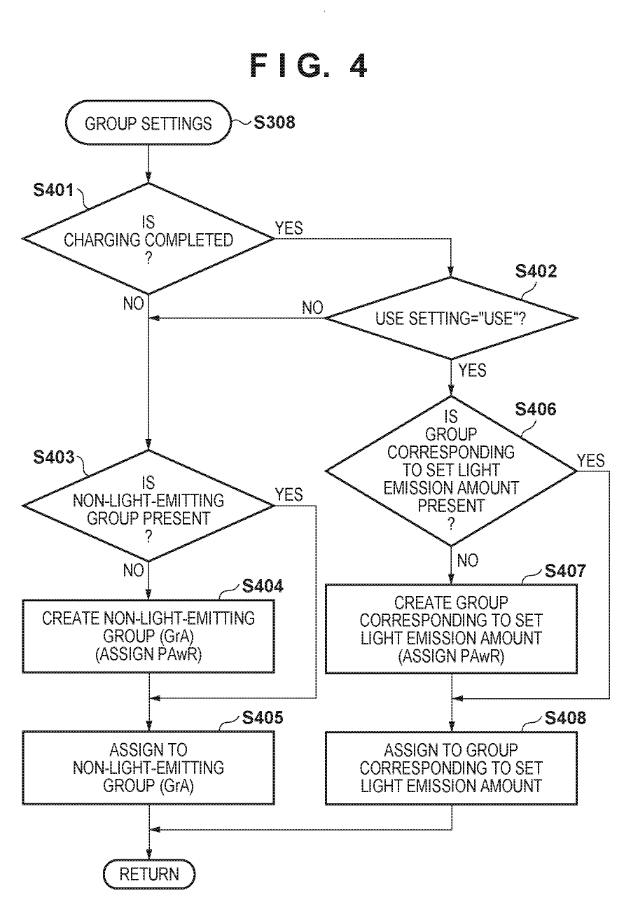

The setting of the strobe group will be described here with reference to FIG. 4. FIG. 4 is a flowchart illustrating details of group setting processing (step S308 of FIG. 3). Here, it is assumed that the camera MPU 112 makes the group settings on the basis of the charging information, the strobe use settings, and the set light emission amount as an example. However, the strobe settings need not include the set light emission amount, and the camera MPU 112 may make the group settings without using the set light emission amount. In this case, each strobe 100 emits light at the maximum light emission amount during shooting.

Note that in FIG. 4, the strobe 100 for which the group settings are to be made is the strobe 100 that transmitted the strobe information obtained in step S304. For example, if the advertising signal is received from the strobe 100b indicated in FIG. 1B and the strobe information is obtained in step S304, the group settings are made for the strobe 100b.

In step S401, the camera MPU 112 determines whether the charging of the strobe 100 is complete on the basis of the charging information. If the charging of the strobe 100 is complete, the sequence moves to step S402; if not, the sequence moves to step S403.

In step S402, the camera MPU 112 determines whether the strobe 100 is to be used during shooting on the basis of the strobe use settings. If the strobe 100 is to be used, the sequence moves to step S406; if not, the sequence moves to step S403.

In step S403, the camera MPU 112 determines whether a non-light-emitting group is present. The “non-light-emitting group” is a group of strobes that are not to be used during shooting (do not receive light emission instructions during shooting). If a non-light-emitting group is present (i.e., if a non-light-emitting group has already been created), the sequence moves to step S405; if not, the sequence moves to step S404.

In step S404, the camera MPU 112 creates a non-light-emitting group (sometimes referred to as “GrA” hereinafter). The camera MPU 112 assigns a specific combination of Subevent and Slot numbers for PAwR communication in the BLE communication standard to GrA. As a result, an advertising signal corresponding to GrA is transmitted during a single period of the transmission of the advertising signal.

In step S405, the camera MPU 112 assigns the strobe 100 to the non-light-emitting group. Information for managing the group assignment is stored in the RAM, for example. In the example in FIG. 1B, if the target strobe 100 is the strobe 100d (charging information = charging incomplete), that strobe 100 is assigned to the non-light-emitting group (GrA).

In step S406, the camera MPU 112 determines whether a group corresponding to the set light emission amount is present. If a group corresponding to the set light emission amount is present (i.e., if a group corresponding to the set light emission amount has already been created), the sequence moves to step S408; if not, the sequence moves to step S407.

In step S407, the camera MPU 112 creates a group corresponding to the set light emission amount. For example, if the set light emission amount is “33”, the camera MPU 112 creates a group to which strobes 100 having the set light emission amount of “33” are to belong (sometimes referred to as “GrB” hereinafter). As another example, if the set light emission amount is “28”, the camera MPU 112 creates a group to which strobes 100 having the set light emission amount of “28” are to belong (sometimes referred to as “GrC” hereinafter). The camera MPU 112 assigns a specific combination of Subevent and Slot numbers for PAwR communication in the BLE communication standard to the groups corresponding to the set light emission amounts. As a result, an advertising signal corresponding to the group corresponding to the set light emission amount (e.g., GrB or GrC) is transmitted during a single period of the transmission of the advertising signal.

In step S408, the camera MPU 112 assigns the strobe 100 to the group corresponding to the set light emission amount. Information for managing the group assignment is stored in the RAM, for example. In the example in FIG. 1B, if the target strobe 100 is the strobe 100a or 100b (set light emission amount = 33), that strobe 100 is assigned to GrB, whereas if the target strobe 100 is the strobe 100c (set light emission amount = 22), that strobe 100 is assigned to GrC.

Returning to FIG. 3, in step S309, the camera MPU 112 determines whether a group change has occurred. If a group change has occurred (i.e., if the group to which the strobe 100 belongs has changed between before and after the most recent instance of the process of step S308), the sequence moves to step S310; if not, the sequence moves to step S312.

In step S310, the camera MPU 112 instructs the camera wireless unit 116 to notify the strobe 100 (the strobe 100 for which the group has been changed in the most recent instance of the processing indicated in FIG. 4) of the changes in the Subevent and Slot numbers using the advertising signal.

In step S311, the camera MPU 112 determines whether a group change completion notification corresponding to the notification in step S310 has been received. If a group change completion notification has been received, the sequence moves to step S312; if not, the sequence returns to step S310.

In step S312, the camera MPU 112 determines whether a shooting start instruction has been made by the user. The user can issue the shooting start instruction to the camera 110 by operating the user operation unit 113, the remote controller 130, or the smartphone 140. If the remote controller 130 or the smartphone 140 is used, the shooting start instruction is transmitted to the camera 110 through BLE communication. If a shooting start instruction has been made, the sequence moves to step S313; if not, the sequence returns to step S303.

In step S313, the camera MPU 112 instructs the camera wireless unit 116 to include a light emission instruction in the parameters of the advertising signals for each group except the non-light-emitting group. The sequence then returns to step S303. Note that the advertising signal including the light emission instruction is transmitted only once per group in a single instance of the processing of step S313.

### Relationship between Advertising Signals and Groups

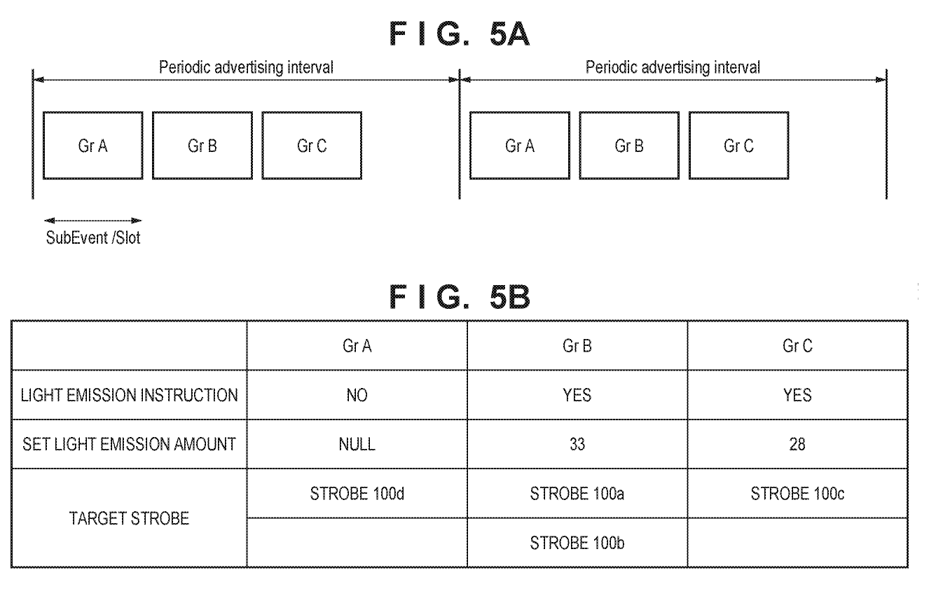

A relationship between advertising signals and groups will be described next with reference to FIGS. 5A and 5B. FIG. 5A is a diagram illustrating the format of advertising signal communication according to PAwR. The communication interval follows the periodic advertising interval specified by the standard, and the advertising signal is repeatedly transmitted periodically.

GrA, GrB, and GrC correspond to examples of the three groups described with reference to FIG. 4. The parameters used for controlling one or more strobes 100 in a group are common, and a common instruction can be issued to all the strobes 100 in a single group by using a single advertising signal having the common parameters.

In addition, GrA, GrB, and GrC are groups formed according to the SubEvent number and the Slot number specified in the BLE standard.

FIG. 5B is a diagram illustrating an example of the strobes and parameters assigned to the respective groups. The grouping example illustrated in FIG. 5B corresponds to the example illustrated in FIG. 4 (and furthermore to the example illustrated in FIG. 1B). The camera MPU 112 performs control so that at least one of the light emission instruction and the set light emission amount illustrated in FIG. 5B is included in the advertising signal.

GrA is a non-light-emitting group and includes the strobe 100d. Since GrA is not used during shooting, the advertising signal addressed to GrA does not include a light emission instruction regardless of whether a shooting start instruction is present. Additionally, as can be seen from FIG. 4, strobes are assigned to GrA regardless of the set light emission amounts, and thus strobes 100 within GrA do not necessarily have the same set light emission amounts. Accordingly, the camera 110 includes “NULL” in the set light emission amount of the advertising signal addressed to GrA.

As mentioned earlier, GrB includes the strobes 100a and 100b. “33” is set for the set light emission amount in the advertising signal addressed to GrB. Additionally, because GrB is used during shooting, if a shooting start instruction is made, the advertising signal addressed to GrB includes a light emission instruction (if a shooting start instruction is not made, the advertising signals for all groups do not include a light emission instruction).

As mentioned earlier, GrC includes the strobe 100c. “28” is set for the set light emission amount in the advertising signal addressed to GrC. Additionally, because GrC is used during shooting, if a shooting start instruction is made, the advertising signal addressed to GrC includes a light emission instruction (if a shooting start instruction is not made, the advertising signals for all groups do not include a light emission instruction).

### Operations by Strobe 100

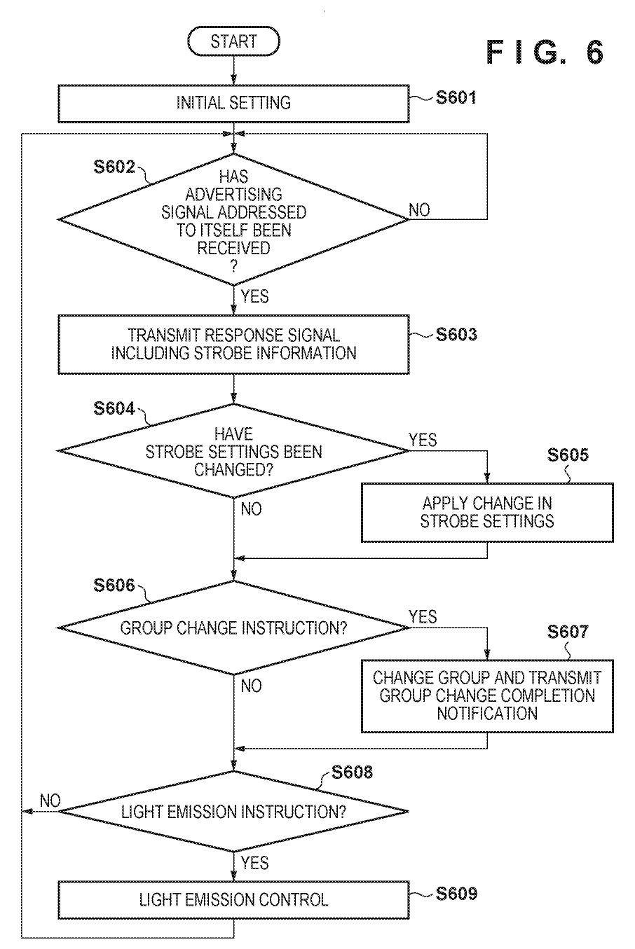

FIG. 6 is a flowchart illustrating operations performed by the strobe 100. Unless otherwise specified, the processes in the respective steps of this flowchart are realized by the strobe MPU 104 executing programs stored in the ROM. The processing of this flowchart starts when a power switch (not shown) of the strobe 100 is turned on.

In step S601, the strobe MPU 104 sets the memory content, executed programs, and the like to an initialized state, and executes preparatory operations such as powering on the light emitting unit 101, the light emission control circuit 102, and the strobe wireless unit 103.

In step S602, the strobe MPU 104 determines whether an advertising signal addressed to the strobe 100 itself (an advertising signal transmitted with Subevent and Slot numbers corresponding to the group to which the strobe 100 belongs) has been received from the camera 110. The strobe MPU 104 repeats the determination of step S602 until an advertising signal addressed to the strobe 100 itself is received. Once an advertising signal addressed to the strobe 100 itself is received, the sequence moves to step S603.

In step S603, the strobe MPU 104 stores the strobe information in a response signal according to PAwR, and notifies the camera 110 of the strobe information by transmitting the response signal. As described earlier, the strobe information can include the maximum light emission amount, the set light emission amount, the charging information, and the like.

In step S604, the strobe MPU 104 determines whether the strobe settings have been changed by referring to the parameters in the advertising signal. If the strobe settings have been changed, the sequence moves to step S605; if not, the sequence moves to step S606.

In step S605, the strobe MPU 104 causes the light emission control circuit 102 to apply the change in the strobe settings (i.e., the changed parameters in the advertising signal) by instructing the light emission control circuit 102 to change the strobe settings. The strobe settings include, for example, the set light emission amount and a strobe use setting (a setting for whether or not to use the strobe).

In step S606, the strobe MPU 104 determines whether an instruction for changing the Subevent and Slot numbers (i.e., a group change instruction) has been received by referring to the parameters in the advertising signal. If a group change instruction has been received, the sequence moves to step S607; if not, the sequence moves to step S608.

In step S607, the strobe MPU 104 changes the Subevent and Slot numbers on the basis of the group change instruction, and as soon as the change is complete, notifies the camera 110 of the group change completion notification using an advertising response signal.

In step S608, the strobe MPU 104 determines whether a light emission instruction has been received by referring to the parameters in the advertising signal. If a light emission instruction has been received, the sequence moves to step S609; if not, the sequence returns to step S602.

In step S609, the strobe MPU 104 issues a strobe light emission instruction to the light emission control circuit 102. The sequence then returns to step S602. Having received the strobe light emission instruction, the light emission control circuit 102 performs control so that light is emitted at the light emission amount set in step S605. The strobe emits light by being energized by a pulse voltage of several KV applied from a trigger circuit, utilizing the electrical energy with which the main capacitor has been charged.

### Summary of First Embodiment

As described above, according to the first embodiment, the camera 110 (an image capturing apparatus) operates as a Peripheral compliant with the Bluetooth Low Energy (BLE) standard, and controls the transmission of an advertising signal (see step S302 in FIG. 3). The camera 110 receives a response signal corresponding to the advertising signal from each of the plurality of strobes 100 (a plurality of light emitting apparatuses) operating as Centrals compliant with the BLE standard (see step S303 in FIG. 3). The response signal includes the strobe information (light emitting apparatus information). The camera 110 divides the plurality of strobes 100 into two or more groups on the basis of a plurality of pieces of strobe information corresponding to the plurality of strobes 100 (see step S308 in FIG. 3, and FIG. 4). The camera 110 performs control such that, for each of the two or more groups, a single advertising signal common to one or more strobes 100 in the group is transmitted to the one or more strobes 100 (see FIGS. 5A and 5B).

In this manner, according to the present embodiment, a plurality of strobes 100 are divided into two or more groups, and a single advertising signal common to one or more strobes 100 in the group is transmitted for each of the two or more groups. Accordingly, the amount of data transmitted can be reduced, and differences in the timings at which the instructions are received by the strobes 100 can be reduced. As a result, differences in the light emission timings between the strobes 100 can be reduced.

Therefore, according to the present embodiment, an image capturing apparatus that operates as a Peripheral can efficiently control a plurality of light emitting apparatuses.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012290, filed January 28, 2025, which is hereby incorporated by reference herein in its entirety.

What is claimed is:

1. An image capturing apparatus that operates as a Peripheral compliant with a Bluetooth Low Energy (BLE) standard, the image capturing apparatus comprising:
a control unit configured to control transmission of an advertising signal;
a first receiving unit configured to receive a response signal corresponding to the advertising signal from each of a plurality of light emitting apparatuses that operate as Centrals compliant with the BLE standard, the response signal including light emitting apparatus information; and
a grouping unit configured to divide the plurality of light emitting apparatuses into two or more groups based on a plurality of pieces of the light emitting apparatus information corresponding to the plurality of light emitting apparatuses,
wherein the control unit performs control such that, for each of the two or more groups, a single advertising signal common to one or more light emitting apparatuses in the group is transmitted to the one or more light emitting apparatuses.

2. The image capturing apparatus according to claim 1,
wherein the grouping unit creates the two or more groups by assigning, to each group, a unique Subevent number and a unique Slot number that are compliant with the BLE standard.

3. The image capturing apparatus according to claim 1,
wherein the light emitting apparatus information includes at least one of (i) a maximum light emission amount and a set light emission amount of the light emitting apparatus and (ii) charging information of the light emitting apparatus, the set light emission amount indicating an amount of light actually emitted in response to a light emission instruction, and the charging information indicating whether charging of the light emitting apparatus is complete.

4. The image capturing apparatus according to claim 1,
wherein the grouping unit divides the plurality of light emitting apparatuses into the two or more groups based on the plurality of pieces of light emitting apparatus information such that one or more light emitting apparatuses controllable using a common parameter are assigned to a same group.

5. The image capturing apparatus according to claim 1,
wherein the control unit performs control such that, for each of the two or more groups, at least one of a light emission instruction and a set light emission amount is included in the advertising signal, the set light emission amount indicating an amount of light actually emitted in response to the light emission instruction.

6. The image capturing apparatus according to claim 5,
wherein the light emitting apparatus information includes charging information indicating whether charging of the light emitting apparatus is complete, and
the control unit performs control such that the light emission instruction is not included in the advertising signal corresponding to a group of light emitting apparatuses for which charging is incomplete.

7. The image capturing apparatus according to claim 5, further comprising:
a setting unit configured to set usage or non-usage for each of the plurality of light emitting apparatuses in accordance with an instruction from a user,
wherein the control unit performs control such that the light emission instruction is not included in the advertising signal corresponding to a group of light emitting apparatuses for which non-usage is set.

8. The image capturing apparatus according to claim 5, further comprising:
a second receiving unit configured to receive a shooting instruction from a control apparatus that operates as a Central compliant with the BLE standard,
wherein the control unit performs control such that, for each of the two or more groups, the light emission instruction is included in the advertising signal in accordance with the shooting instruction.

9. The image capturing apparatus according to claim 8,
wherein the control apparatus is a remote controller or a smartphone.

10. A light emission control system comprising:
the image capturing apparatus according to claim 1; and
the plurality of light emitting apparatuses.

11. A control method executed by an image capturing apparatus that operates as a Peripheral compliant with a Bluetooth Low Energy (BLE) standard, the control method comprising:
controlling transmission of an advertising signal;
receiving a response signal corresponding to the advertising signal from each of a plurality of light emitting apparatuses that operate as Centrals compliant with the BLE standard, the response signal including light emitting apparatus information; and
dividing the plurality of light emitting apparatuses into two or more groups based on a plurality of pieces of the light emitting apparatus information corresponding to the plurality of light emitting apparatuses,
wherein the controlling performs control such that, for each of the two or more groups, a single advertising signal common to one or more light emitting apparatuses in the group is transmitted to the one or more light emitting apparatuses.

12. A non-transitory computer-readable storage medium which stores a program for causing a computer of an image capturing apparatus, which operates as a Peripheral compliant with a Bluetooth Low Energy (BLE) standard, to execute a control method comprising:
controlling transmission of an advertising signal;
receiving a response signal corresponding to the advertising signal from each of a plurality of light emitting apparatuses that operate as Centrals compliant with the BLE standard, the response signal including light emitting apparatus information; and
dividing the plurality of light emitting apparatuses into two or more groups based on a plurality of pieces of the light emitting apparatus information corresponding to the plurality of light emitting apparatuses,
wherein the controlling performs control such that, for each of the two or more groups, a single advertising signal common to one or more light emitting apparatuses in the group is transmitted to the one or more light emitting apparatuses.
